(19) United States
(12) Patent Application Publication
(10) Pub. No.: US 2007/0243431 A1
(43) Pub. Date: Oct. 18, 2007

(54) Hydrogen-generating solid fuel cartridge

(75) Inventors: Guang-Hui Zhu, Fremont, CA (US); Xiao-Dong Xiang, Danville, CA (US); Jonathan Melman, San Mateo, CA (US)

Correspondence Address: BUCHANAN, INGERSOLL & ROONEY PC, POST OFFICE BOX 1404, ALEXANDRIA, VA, 22313-1404, US

(73) Assignee: Intematix Corporation, Fremont, CA (US)

(21) Appl. No.: 11/707,501

(22) Filed: Feb. 15, 2007

Related U.S. Application Data
(60) Provisional application No. 60/774,913, filed on Feb. 17, 2006.

(51) Int. Cl. H01M 8/18

(52) U.S. Cl. 429/19

(57) ABSTRACT

Disclosed herein is a novel hydrogen-generating, solid fuel cartridge which may be used to provide hydrogen to a proton exchange membrane (PEM) fuel cell. The cartridge contains a mixture of the hydrogen-generating solid fuel and a catalyst. The solid fuel/catalyst mixture has a packing fraction greater than about 55 percent. Throughout the fuel/catalyst mixture is means for distributing the liquid reactant; there is also a network of hydrogen-collecting, gas permeable membranes for removing the hydrogen product from the cartridge. The hydrogen-generating solid fuel cartridge may further include a liquid reactant distribution plate for distributing the liquid reactant to the solid fuel/catalyst mixture in a substantially uniform manner. The distribution plate has distribution channels arranged in a fractal pattern.

### CROSS-REFERENCE TO RELATED APPLICATIONS

This application claims the benefit of priority of U.S. Provisional Patent Application Ser. No. 60/774,913, filed Feb. 17, 2007, the specification and drawings of which are incorporated herein by reference.

### BACKGROUND OF THE INVENTION

1. Field of the Invention

The present invention is directed in general to hydrogen-generating solid fuel cartridges. Specifically, the present invention is directed to systems and methods of generating hydrogen from a solid fuel cartridge, the product hydrogen then being made available to a proton exchange fuel membrane (PEM) fuel cell.

2. Description of Related Art

The proton exchange membrane fuel cell (PEMFC) is a promising technology for supplying energy to portable electronic devices because of its high power density and its zero-emission of greenhouse gases. Hydrogen is required to power a PEMFC. For portable electronic applications, a hydrogen storage system is desired to have a large hydrogen storage density based on both system weight and volume, such that the PEMFC can compete with current lithium-ion batteries and nickel-metal hydride batteries.

Hydrogen can be stored in the form of a high pressure gas or a liquid, but each of these methods requires high pressure operation which imposes stringent requirements for the storage materials. Neither is deemed safe, nor is either easy to use in portable systems. Furthermore, the deliverable energy density for liquid hydrogen or high pressure hydrogen gas is low. Liquid hydrogen has density of 0.070 kg/L; while hydrogen gas at 10,000 psi has a density of 0.030 kg/L. It is known in the art that 30% of the heat value of hydrogen is typically required to liquefy hydrogen. After considering the energy required for liquefaction, the deliverable density for liquid hydrogen is below 0.050 kg/L. Due to these factors, seeking an alternative hydrogen source becomes imperative.

Chemical hydrides and metal hydrides are currently under investigation for hydrogen storage. Considering the most critical factors for portable electronics (hydrogen storage density and release rate), chemical hydrides appear to be more desirable.

One of the most studied chemical hydride systems is the reaction between sodium borohydride and water. A reaction between sodium borohydride (NaBH₄) and water (H₂O) may generate hydrogen at appreciable rates at room and higher temperatures when proper catalysts are used. The reaction may be described by the following equation:
NaBH₄+4H₂O=NaB(OH)₄+4H₂ (1)
The hydrogen density for this reaction is about 7.4 wt %: the calculation made by considering the stoichiometric relationships between NaBH₄ and water in the above equation.

Two different approaches have been taken in the past to utilize this reaction system. In one approach, as described in U.S. Pat. No. 6,932,847, sodium borohydride is mixed with water to form a sodium borohydride solution. The pH of the solution is maintained at a value greater than about 7, with the resulting solution forced through a catalyst bed to generate the hydrogen product. U.S. Pat. No. 6,932,847 discloses a system that includes a fuel container containing the NaBH₄ solution, a spent fuel container containing a NaB(OH)₄ solution, a reactor packed with the catalyst, and associated controlling parts.

A disadvantage of this system is that for proper operation, the concentration of sodium borohydride should not be greater than about 25 wt % so that enough water remains after the reaction to dissolve the product NaB(OH)₄ that is formed. It is desirable to maintain the NaB(OH)₄ product in solution so that it will not precipitate and/or clog the channels inside the reactor. If this happens, it is difficult for the reaction to continue. In U.S. Patent Application 2003/0009942, a NaBH₄ solution containing 20% NaBH₄ by weight was used (with 4% NaOH). For this situation, the NaBH₄ solution is not reacted inside the fuel tank so as to avoid dilution of the NaBH₄ solution. Such a dilution would result in a reduction of the rate of hydrogen generation.

A second approach previously attempted was to store the liquid water and the solid sodium borohydride separately. Water is delivered to sodium borohydride when hydrogen is needed and the sodium borate waste product remains at the same location as the sodium borohydride was before being consumed. For this situation there is no solubility issue, and therefore no additional container is needed to store the spent fuel. Theoretically, the amount of water generated by the fuel cell will be the same as the amount of water which reacted with the sodium borohydride, and the hydrogen storage density may therefore approach 23 wt %. In practical applications, however, additional water is required considering the partial conversion of hydrogen within the fuel cell, and the water vapor that escapes with the exhaust air. These disadvantages notwithstanding, the hydrogen storage density is still greater than that described above for the solution based processes.

U.S. Pat. No. 6,746,496 disclosed a system for hydrogen generation using the second of the two approaches mentioned above. The system taught by this patent utilized a water-storage cavity and a fuel-storage cavity built into the top surface of a single substrate. Capillary flow channels were used to transport water from the water-storage cavity to the fuel-storage cavity, the mechanism of the transport being, of course, capillary action. The top surface of the substrate was sealed by a cover lid. Such an approach requires the sodium borohydride fuel to be in the form of micro-dispersed particles so that water transportation within the fuel-storage cavity containing the sodium borohydride may be achieved by “pulling” water between the packed particles.

The disadvantages inherent with the practical application of the capillary approach taught by U.S. Pat. No. 6,746,496 are numerous. First, the solid hydrogen-fuel source is located on the same substrate as the water reservoir, along with the dispensing channel and flow controlling valve; such that the assembly/module is not readily and/or conveniently disposable. When the solid hydrogen source is consumed (“used up”), the entire module needs to be removed to replenish the sodium borohydride. A second disadvantage is that although water is recycled from the fuel cell, the configuration of this hydrogen generation system does not allow recycled water to reach the sodium borohydride, since there is no channel on the substrate connecting to an external water source. A third disadvantage is that micron-sized particles of solid hydrogen-source materials are closely-packed in the solid fuel cavity. To achieve such a design, a restricted particle size of sodium borohydride is required, which makes the manufacturing of sodium borohydride costly. Furthermore, the reacted particles may collapse to form a dense layer of product, preventing water from flowing through the particle bed.

What is needed is a better system design that substantially improves upon the second approach for hydrogen generation. The present invention provides such an improved system, demonstrating an enhanced flexibility in size, dimension, efficiency, and the potential to solve the issues mentioned above.

### SUMMARY OF THE INVENTION

A first embodiment of the present invention provides a hydrogen-generating solid fuel cartridge for reacting a liquid reactant with a solid fuel, the cartridge comprising an outer shell of the cartridge containing a mixture of the hydrogen-generating solid fuel and a catalyst. The solid fuel/catalyst mixture has a packing fraction greater than about 55 percent (or stated another way, a void fraction less than about 45 percent). The outer shell of the cartridge has an entry port for introducing liquid reactant into the cartridge; the entry port is connected to a means for distributing the liquid reactant substantially evenly throughout the solid fuel/catalyst mixture within the cartridge. There is also a network of hydrogen-collecting, gas permeable membranes dispersed within the solid fuel/catalyst mixture, the network of membranes communicating to at least one hydrogen exit port in the outer shell for removing the hydrogen product from the cartridge.

In an alternative embodiment, the present hydrogen-generating solid fuel cartridge further includes a liquid reactant distribution plate for distributing the liquid reactant to the solid fuel/catalyst mixture in a substantially uniform manner. The distribution plate has distribution channels arranged in a fractal pattern, one end of the fractal pattern connected to the entry port in the outer shell (and hence to the liquid reactant supply), the other end of the fractal pattern connected to the means for distributing the liquid reactant throughout the solid fuel/catalyst mixture. The distribution means within the solid fuel/catalyst mixture may be a network of fluid channels, the proximal ends of which are connected to the distal ends of the fractal pattern in the distribution plate.

This embodiment employs a fractal distribution pattern for liquid distribution. Channels and holes are provided on the plate for the fractal-like liquid distribution. The channels conduct liquid from an inlet in the center of the plate to the holes, which are uniformly distributed on the plate, and these conduct liquid from the plate to the solid reactant.

Another embodiment of the present invention provides a hydrogen-generating solid fuel cartridge as described above, connected specifically to a portable proton exchange membrane (PEM) fuel cell battery. This system comprises the solid fuel cartridge, a PEM fuel cell connected to the hydrogen output of the solid fuel cartridge; and a means for recycling water produced by the PEM fuel cell back to the solid fuel cartridge. The reservoir provides all or part of the liquid reactant for the reaction with the solid fuel/catalyst mixture contained within the cartridge. In this embodiment, a dispensing plate with a fractal distribution pattern may be used to distribute liquid uniformly across a surface of the cartridge.

In another embodiment of the present invention, a gas collecting, hydrophobic (water-based liquid-repelling) material is packed inside the solid reactant cartridge to collect hydrogen that has been generated during the reaction between the solid fuel and the liquid reactant. This material may comprise a network of membranes, and because the membranes are water-repellent and gas permeable, the hydrogen generated within the solid fuel cartridge may diffuse and be transported outside the cartridge. Simultaneously, the hydrophobic nature of the hydrogen-collecting membranes prevents water from exiting the cartridge along with the hydrogen product.

It is emphasized that the present invention mixes the solid reactant in the fuel cartridge with the catalyst to improve the reaction with the liquid reactant. The catalyst may be premixed with the solid fuel reactant and then packed into the cartridge, or packed together while loading into the cartridge.

In another embodiment of the present invention, the solid reactant can be premixed with additives to improve reaction probabilities. Such additives might not be described as a “catalyst,” though, because the additives may participate in the reaction that generates the hydrogen.

The means for distributing the liquid reactant throughout the solid fuel/catalyst mixture in the cartridge may be connected with the liquid dispensing plate such that liquid can flow via these means into the bulk of the mixture in predetermined patterns that are not symmetrical or uniform. Any three dimensional pattern may be designed for dissipating the liquid reactant into the surrounding solid fuel. The distribution medium may take a variety of forms; for example, a two-dimensional membrane in flat or sheet form, or a one dimensional hollow tube. In this latter embodiment, the solid fuel reactant may be mixed with fibers having capillary channels. The capillary channels have the ability to wick liquid from one end of a fiber to the other. The fibers may be interconnected inside the solid reactant cartridge, and are in contact with the liquid conducting medium. In this manner, a liquid distribution network is formed inside the solid reactant cartridge, with water acting as the conducting media, and the fibers functioning as local channels for the main channel. Such a network reduces the diffusion barrier for liquid inside the solid reactant package.

### BRIEF DESCRIPTION OF THE DRAWINGS

FIG. 1 is a schematic drawing of the present flex-dimension hybrid fuel system;

FIG. 2A is a drawing of an outer shell of the hybrid fuel package;

FIG. 2B is a drawing of a hydrophopic H₂-accepting layer, designed to allow diffusion into the layer of the H₂ product, while simultaneously preventing the diffusion of water reactant (the layer may be an aerogel foam);

FIG. 2C is an exemplary assembly of the hydrophobic, H₂ diffusing foam with the outer shell of FIG. 2A;

FIG. 2D is a diagram showing the relationship between the assembly of FIG. 2C with the hollow fiber membrane (which may be water flow channels) of the cartridge, and the solid fuel H₂ source material (which may be NaBH₄);

FIG. 3 is a diagram of a cross-section of the fuel cartridge showing its operation, and the relationships between the hollow fiber membrane/channels, the solid fuel H₂ source material, and the H₂ diffusing layer;

FIG. 4A is a diagram of an exemplary cover plate for the cartridge;

FIG. 4B is a diagram of an exemplary water flow plate with a fractal flow pattern;

FIG. 5 is a diagram showing an alternative configuration of the packing of the aerogel foam and the solid hydride fuel (H₂) source within the fuel cartridge;

FIG. 6 is a schematic design showing how the present flex-dimension hybrid fuel system may be integrated with a portable PEMFC battery;

FIG. 7 is a schematic drawing of an exemplary testing set-up;

FIG. 8 is a graph showing exemplary results of H₂ generation from an exemplary single cell when 20 wt % RuCl₃ is packed with NaBH₄;

FIG. 9 is a graph showing exemplary results of H₂ generation from an exemplary single cell when 20 wt % CoBr₂ is packed with NaBH₄; and

FIG. 10 is a graph showing exemplary results of H₂ generation from an exemplary single cell when 20 wt % FeCl₂ is packed with NaBH₄.

### DETAILED DESCRIPTION OF THE INVENTION

The present invention is directed to methods and systems for generating hydrogen by reactions between the contents of a solid, fuel-providing cartridge, and a liquid reactant delivered to the fuel-providing cartridge. In one embodiment of the present invention, a solid, hydrogen-generating material is packed in a portable cartridge, and a liquid reactant is delivered to the cartridge to generate the hydrogen. The hydrogen produced from the hydrogen-providing, solid fuel cartridge may then be transported out of the package to be utilized in PEM fuel cell applications.

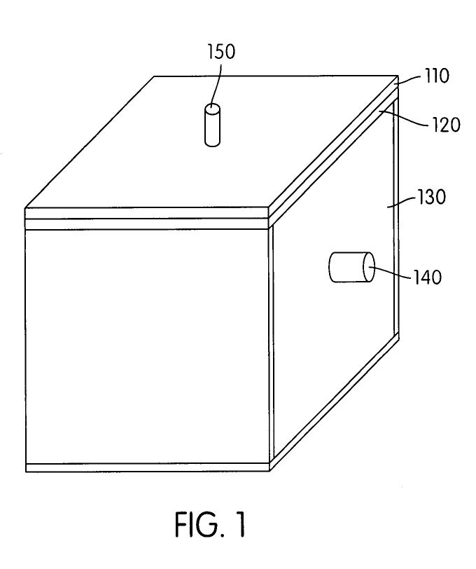

The manner in which such an exemplary fuel cartridge might appear from the exterior is illustrated schematically in FIG. 1. As it would appear to the user, a liquid reactant such as water is delivered through an entry port 150 to the sodium borohydride contents (not visible in FIG. 1) inside the cartridge. The hydrogen generated from the reaction occurring within the cartridge may be removed from the cartridge in various ways, but in the example illustrated in FIG. 1, the product hydrogen exits from a port 140 located on a side of the cartridge.

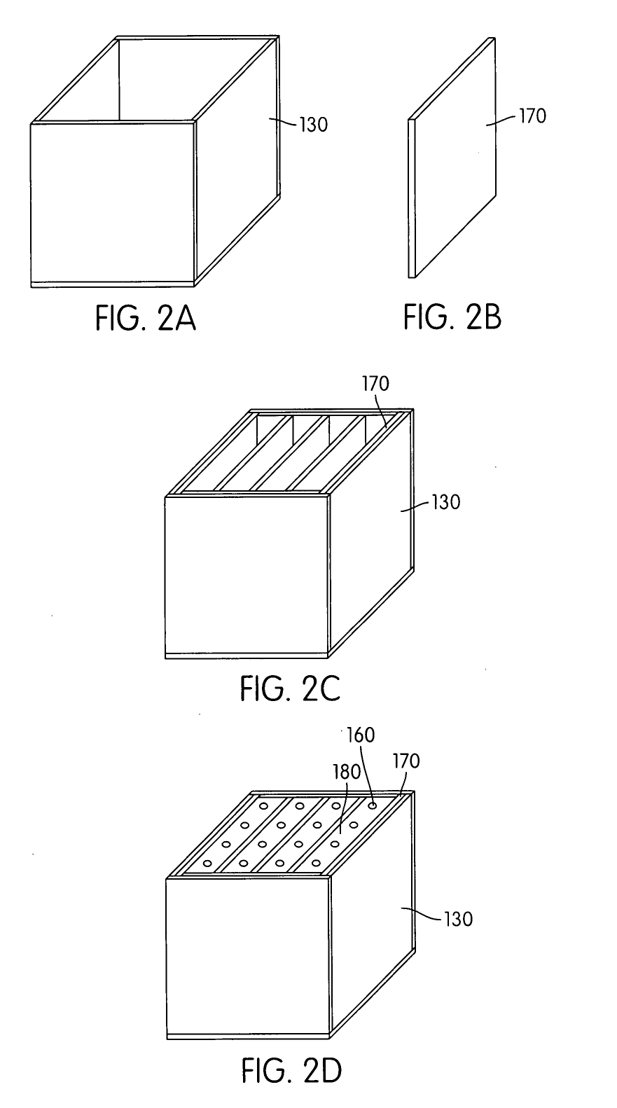

Embodiments of the present invention provide for novel means of consolidating the hydrogen produced within the cartridge. This means of consolidation and/or collection may comprise a thin aerogel foam layer or membrane, or network of layers or membranes. FIG. 2A shows an exemplary outer shell of the hybrid fuel package, and FIG. 2B shows one layer of an exemplary means for collecting the hydrogen, in this case a hydrophopic, hydrogen (H₂) collecting layer. This layer in FIG. 2B, shown isolated from the cartridge for the purposes of illustration, is designed to allow diffusion of the hydrogen product into the collecting layer 170, while the collection process simultaneously prevents the diffusion of the liquid reactant (e.g., water) into the layer 170. The layer/membrane 170 may be a foam.

There are virtually an unlimited number of configurations and arrangements for positioning the hydrogen collection layers and/or membranes inside the cartridge. Of course, a simple arrangement is just to have the outer walls of the cartridge lined with the hydrogen collection layers; alternatively, in some embodiments there may be multiple hydrogen collection layers, parallel to one another, positioned within the cartridge, extending from one internal surface of the outer shell of the cartridge to an opposite side. FIG. 2C shows an exemplary assembly of the hydrophobic, H₂ diffusing foam with the outer shell of FIG. 2A, where in this particular case the outer shell is square in cross section, and there are five parallel hydrogen collection membranes extending from one side of the cartridge to the opposite side. The cross section of the shell need not be square; if it were rectanglar, for example, then the series of hydrogen collection layers could either run in a longitudinal direction, along the longer axis of the rectangle, or in a latitudinal direction, along the shorter axis. If the cross section were circular, the hydrogen collection layers might comprise concentric, annular shapes, connected with radially directed layers.

FIG. 2D shows the relationship between the assembly of FIG. 2C (external shell 130 with internally positioned hydrogen collection layers 170), the means for delivering the liquid reactant to the hydrogen-producing solid fuel cartridge 160, and the solid fuel H₂ source material 180. In some embodiments, the liquid reactant may be transported through the cartridge using hollow fibers, or hollow fiber membranes. The hollow fibers, or membrane containing hollow fibers (160) may be water flow channels.

The solid fuel H₂ source material (180) may be sodium borohydrode (NaBH₄). Alternatively, the hydrogen-generating solid fuel contained within the cartridge may be selected from the group consisting of sodium borohydride (NaBH₄), lithium borohydride (LiBH₄), magnesium borohydride (Mg(BH₄)₂), calcium borohydride (Ca(BH₄)₂), aluminum borohydride (Al(BH₄)₃), zinc borohydride (Zn(BH₄)₂), potassium borohydride (KBH₄), lithium aluminum hydride (LiAlH₄), and sodium boron trimethoxyhydride (NaBH(OCH₃)₃).

In one embodiment of the present invention, the present hydrogen-generating solid fuel material 180 may be mixed with a catalyst designed to accelerate the reaction with the liquid reactant. Catalysts capable of catalyzing the reaction shown in equation (1) are known in the art, and are typically based on transition metals. The catalysts of the present embodiments are compounds based on, but not limited to, ruthenium, iron, cobalt, nickel, copper, manganese, tungsten, vanadium, molybdenum, rhodium, rhenium, platinum, palladium, chromium, silver, osmium, iridium, and salts thereof. Specific catalysts useful in the present embodiments include nano-particles of a metallic element selected from the group consisting of Ru, Co and Fe. The catalysts in the mixture may comprise a nano-particle of a metallic compound selected from the group consisting of Ru, Co and Fe, wherein the Ru, Co, or Fe compound is reduced to metallic Ru, Co, or Fe by reacting with the hydrogen-containing solid fuel. Specific solid fuel/catalyst mixtures include 20 wt % RuCl₃ packed in NaBH₄, 20 wt % CoBr₂ is packed in NaBH₄; and 20 wt % FeCl₂ in packed NaBH₄.

In embodiments of the present invention, the solid fuel/catalyst mixture material is packed with a packing fraction greater than about 55 percent (stated alternatively, a void fraction less than about 45 percent). Those skilled in the art will realize that such a mixture may have limited ability to conduct or allow fluids to diffuse within the material; thus, the present embodiments provide for specific liquid reactant diffusion mechanisms. The means for encouraging the diffusion of liquids through the solid fuel/catalyst mixture may comprise the insertion into the mixture/material of fluid channels such as those provided, for example, by a network of hollow fibers. Alternatively, the means for inducing the diffusion of a liquid through the solid fuel/catalyst mixture may be insertion of a layer, or network of layers or membranes, of a material that is designed to conduct liquids. In the first case, where a network of hollow fibers is used, it is useful to employ a liquid distribution plate on at least one surface of the cartridge, the distribution plate having exit holes that align with the ends of the hollow fibers.

It is emphasized that the sodium borohydride (and/or hydrogen generating solid fuel, where sodium borohydride is being used as an example) cartridge of FIGS. 2A-2D is illustrated as just one of many possible configurations of the three basic components. The particular configuration shows a thin layer of aerogel foam (170) adjacent to the interior surface of each of the four sides of the outer shell (130) of the package/cartridge, the outer shell surrounding the sodium borohydride (180). This particular cartridge also has three layers of thin aerogel foam extending from one side of the cartridge to the other, running inside the sodium borohydride material. The foam layers are interconnected such that hydrogen can be transported between them, throughout the cartridge. This cartridge has 16 hollow fiber membranes (160) also running through the sodium borohydride material, from the top of the cartridge where their ends are open, throughout the vertical dimension to the bottom, where the bottom ends are sealed.

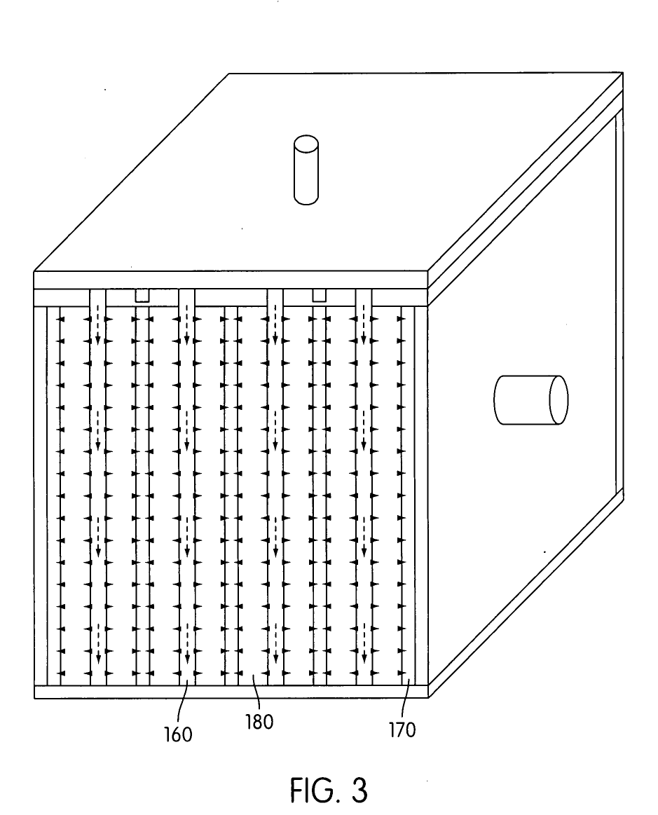

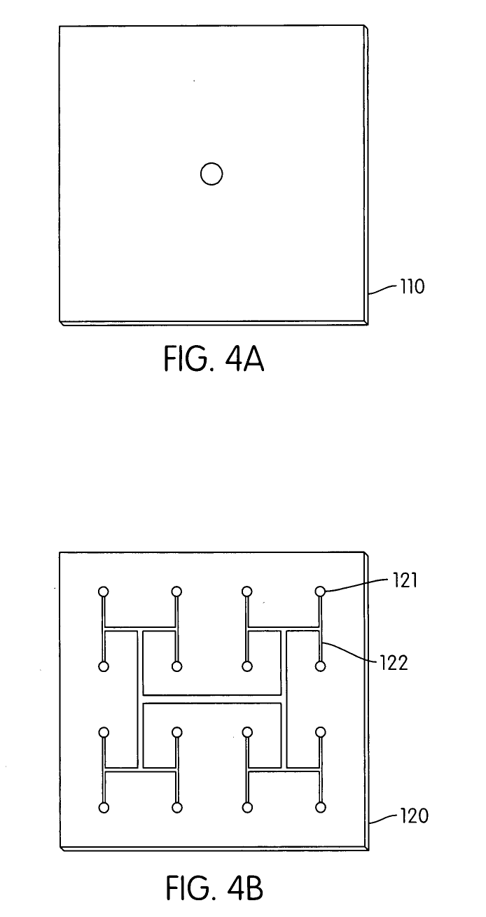

Before turning to the novel manner in which the distribution patterns of the liquid reactant (e.g., water) is determined, it is useful to discuss the operation of the cartridge. Operation of the cartridge may be demonstrated using FIG. 3, which is a diagram of a cross-section of the fuel cartridge showing the relationships between the hollow fiber membrane/channels, the solid fuel H₂ source material, and the H₂ diffusing layer. During the operation of this particular cartridge, water is delivered from a dispensing plate (to be discussed later with reference to FIG. 4) into the hollow fibers 160. Water flows within the inside of the hollow fibers 160 throughout its length, and thus it will be apparent to one skilled in the art that the water is distributed substantially evenly throughout the vertical dimension of the cartridge. In other words, there is no gradient of water concentration between (in this case) the top and bottom of the cartridge.

The water then diffuses through the fiber wall to go out of the fiber and into the bulk of the sodium borohydride 180. After reaching the solid fuel, reaction between the liquid water and the solid sodium borohydride generates hydrogen, which then diffuses into the aerogel foam 170. The liquid reactant, in this case water, is not able to diffuse into the aerogel foam 170, and thus the foam acts as a means to keep the reactants and the products of the reaction separated.

Next, the unique manner in which the liquid reactant is evenly distributed to the various regions of the cartridge will be discussed with reference to FIGS. 4A and 4B. Referring to FIGS. 4A and 4B, the cartridge contains a cover plate 110 (shown in a plan view in FIG. 4A), and a water flow plate or water dispensing plate 120 (shown in a plan view in FIG. 4B). The water dispensing plate 150 sits on top of the cartridge, with the cover plate 110 above it; in other words, the cover plate 110 seals the water dispensing plate 110 against the surface of the cartridge to which the water is delivered (in this case, its top).

A novel feature of the present invention is that the water dispensing plate 120 contains distribution channels 122 arranged in a fractal pattern. An exemplary fractal distribution pattern is illustrated in FIG. 4B. The distribution channels 122 are arranged such that water enters a first channel having the largest diameter from hole 150 in the cover plate 110. This first channel with the largest diameter of any of the water distribution channels in the plate 120 is shown as the thickest, black horizontal line extending through the center of the water dispensing plate 120 in FIG. 4B. From the first channel with the largest diameter, water then flows into each of two channels having a diameter smaller than the first channel, but still the second largest diameter of any of the water distribution channels in the plate 120. These secondary channels are shown as two vertical lines in FIG. 4B. From there, water flows into each of four channels having yet a smaller diameter; the third largest diameter of the plate 120. From there, the liquid flows to eight channels having yet smaller diameters, the fourth largest diameter of the water delivery channels of the plate. In this case, because there are four sizes of channels total, these eight channels have the smallest diameter of any of the channels of the plate. At the ends of each of the horizontally oriented eight smallest diameter channels are through-holes 121, which connect to the ends of the vertically oriented hollow fibers 160. There are 16 of these holes 121, one hole for each of the hollow fibers.

The diameter of any of the channels is less than the thickness of the plate 120, so that water stays in the plate 120 until it is delivered to the holes 121. In one embodiment, the 16 holes 121 are uniformly distributed on the water distributing plate 120 to connect to the holes 121 and align with the hollow fibers 160, but there may be situations where non-uniform patterns are desired.

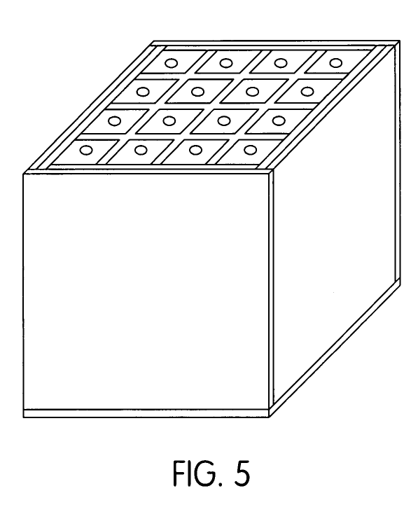

The cover plate 110 may be aligned at its outer edges with the water distribution plate with the fractal pattern 120, but it does not have to be; all that is required is that the hole 150 in the cover plate allow water to flow into the largest diameter channel of the distribution plate 120, and that the cover plate 110 seals the top of the cartridge. The hole 150 in the cover plate 110 communicates with a reservoir 500 or fuel cell 200, to be discussed next. It will be apparent to one skilled in the art how the fractal hole pattern of FIG. 4B lines up with the hollow fiber pattern of a cartridge shown in FIG. 5, in this case the cartridge having two sets of aerogel foam layers for collecting hydrogen, each set having five parallel layers. One set runs horizontally; the second set is perpendicular to the first and thus runs vertically. In a plan view, each of the water distribution holes 121 of water distribution plate 120 sits in the middle of a square of aerogel foam.

It is noted that a novel feature of the present embodiments is that the solid mixture of the hydrogen-generating fuel and catalyst is more densely packed than the solid fuels of previous disclosures. This is because an advantageous means of distributing the liquid reactant throughout the solid fuel/catalyst mixture has been provided (hollow fiber fluid channels in one embodiment; the inclusion of a fibrous membrane in another embodiment), and loose packing of fuel/catalyst particles in a deliberately designed porous structure, such that the liquid diffuses through the spaces and interstices of the particles, is not relied upon. Since the method of encouraging distribution of liquid reactant throughout the solid fuel/catalyst mixture is an added structure (fiber/membrane), and not interstitial spaces that rely on capillary flow, much denser mixtures may be used. According to the present embodiments, the packing fraction of the solid fuel/catalyst mixture is greater than about 55 percent (again, which is equivalent to a void fraction less than about 45 percent).

In one embodiment, a deeply grooved fiber called 4DG may be used to conduct water from the hollow fibers to other places within the solid fuel. This is contemplated to have the same effect as a fibrous membrane. The 4DG fiber has grooves outside the fiber which can act a means to conduct a liquid. This may be by capillary action.

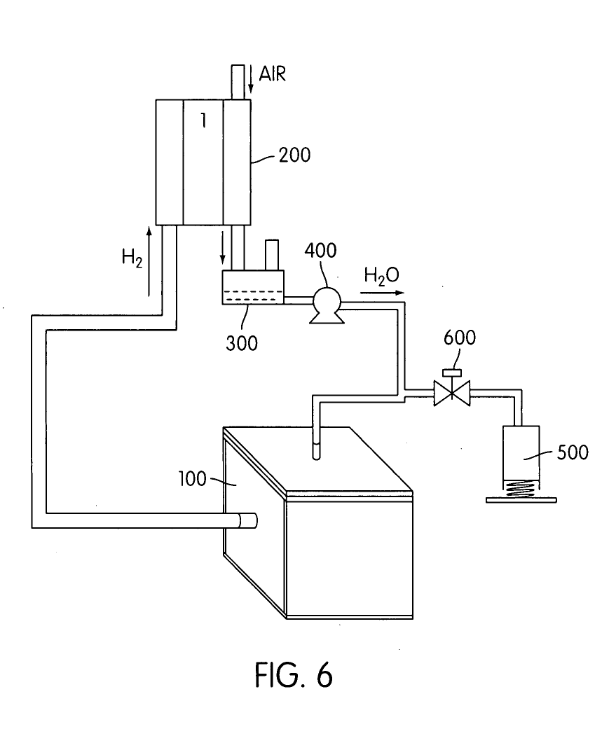

Next, the manner in which the present hydrogen-generating solid fuel cartridge is integrated into a portable power supply system will be discussed with reference to FIG. 6. Referring to FIG. 6, water from a reservoir 500 is pumped to the solid fuel cartridge to generate hydrogen. The hydrogen generated is transported to a fuel cell 200 to generate power. Simultaneously with the power generation, hydrogen is oxidized by oxygen to form water in the fuel cell. This product water may be separated from the oxidant of the fuel cell (the oxidant may be, for example, either oxygen or air) at a gas/liquid separator 300, and then pumped into the hydrogen-generating, solid fuel cartridge 100 using a liquid pump 400. If the amount of product water generated by the fuel cell is insufficient for the reaction between the liquid chemical (water) and the solid fuel, additional water may be provided from the reservoir 500. The amount of flow of the additional water from reservoir 500 may be regulated by the control valve 600.

In operation, the control valve 600 regulates the flow of liquid reactant (e.g. water) from the reservoir 500 to the cartridge 100 via the liquid pump 400. The reaction between the solid fuel/catalyst mixture and the liquid reactant may be triggered (initiated) by the flow of liquid from the separately-located liquid reservoir. Once the reaction is initiated, it may be sustained by the flow of liquid from the fuel cell, the reservoir, or a combination of both simultaneously. Alternatively, if a higher rate of reaction is desired, the flow of liquid from the fuel cell to the cartridge may be augmented by a flow of liquid from the reservoir to the cartridge.

### EXAMPLES

Test Setup

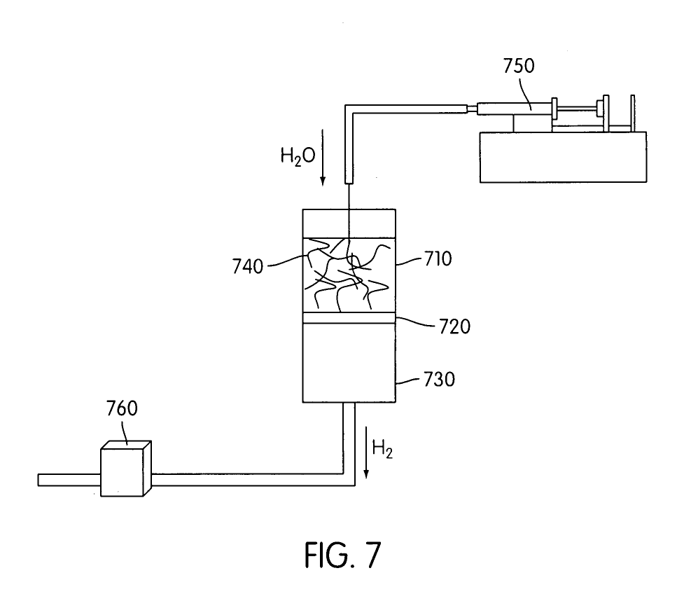

An exemplary setup for testing hydrogen generation in a single cell is shown diagrammatically in FIG. 7. In the following examples, sodium borohydride was ball-milled with a catalyst chosen from RuCl₃, CoBr₂ or FeCl₂ to achieve intimate contact between the sodium borohydride and the catalyst. The mixture of solid fuel sodium borohydride and catalyst 710 was then mixed with shredded filter paper 740, which has the requisite channels for transporting water.

The test cell was loaded with Nanogel™ particles 730 from Cabot Corporation. A thin aerogel foam from Aspen Aerogels Inc. 720 covered the Nanogel™ particles. These two materials were chosen because both the aerogel foam and Nanogel™ particles are hydrophobic. Placed on top of the aerogel foam was a mixture of sodium borohydride and the catalyst, with strips of filter paper positioned inside the sodium borohydride/catalyst mixture. The filter paper strips 740 function as the means for conducting water inside the sodium borohydride/catalyst mixture.

Water was then delivered to the surface of the sodium borohydride/catalyst mixture, and diffusion of the water into the bulk of the sodium borohydride/catalyst mixture and throughout the mixture occurred because of the presence of the filter paper strips 740. Water delivered to the mixture by syringe pump 750 resulted in the generation of hydrogen. The rate of hydrogen production was recorded by a mass flow meter 760, which may measure either mass or volume. This test cell functioned according to the principles of the embodiments described above, in that the interface between the aerogel foam and the sodium borohydride mixture formed a barrier to water diffusion due to the hydrophobic properties of the aerogel foam. Simultaneously, the hydrogen generated passed through the region of aerogel foam 720 and and Nanogel™ particles 730 because of the porous nature of these materials.

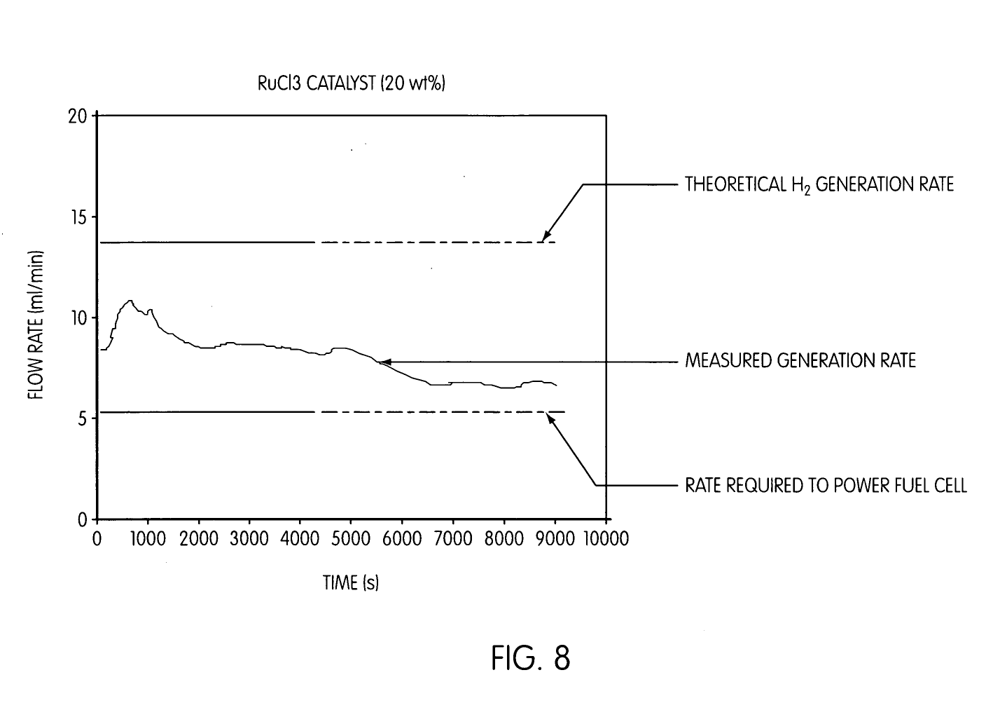

The results of the experiments are shown in FIGS. 8-10.

### Example 1

The results of the experiment when the hydrogen-generating solid fuel is sodium borohydride NaBH₄ and the catalyst is 20 wt % RuCl₃ is shown in FIG. 8. There are three curves in the graph. The actual hydrogen generation rate, measured using the mass flow meter, is plotted on the graph. The theoretical hydrogen generation rate, a calculation based on the water delivery rate and equation (1) is also plotted on the graph for comparison. The third curve on the graph is the hydrogen generation rate that would be required to power a typical laptop computer. Although an excess of water was required above that which the fuel cell generated, the results indicate that hydrogen generation rate met the power requirements of the laptop.

### Example 2

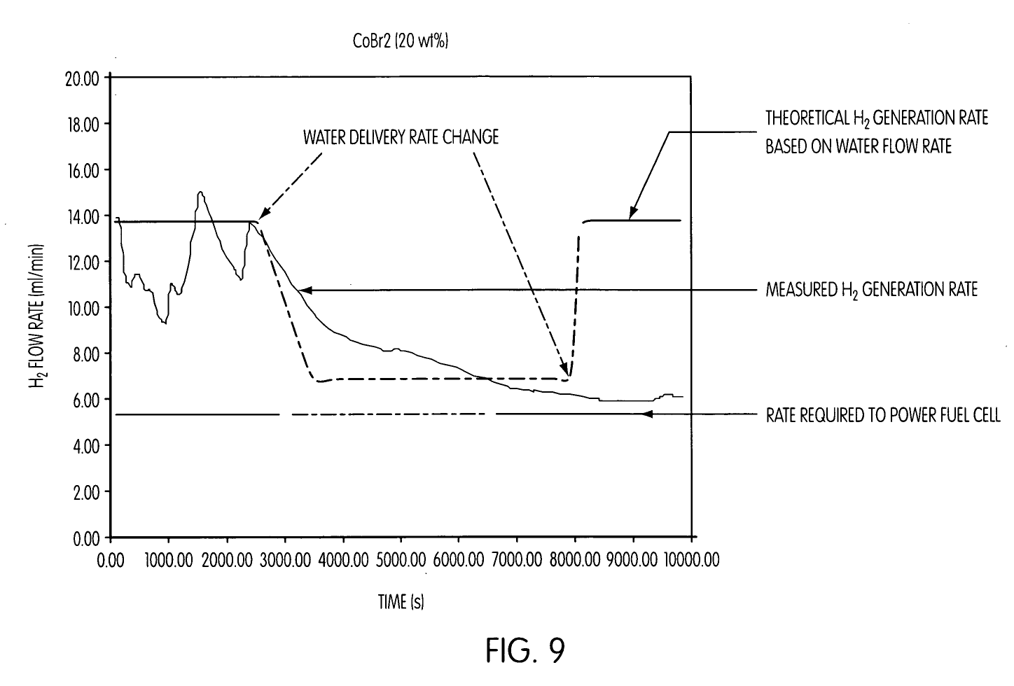

The results of the experiment when the hydrogen-generating solid fuel is sodium borohydride NaBH₄ and the catalyst is 20 wt % CoBr₂ is shown in FIG. 9. This experiment was performed in a slightly different manner, in that the water delivery rate to the fuel cell was changed twice (the first time at about 2500 seconds into the experiment; the second time at about 8000 seconds). The decrease in the hydrogen generation rate corresponding with the decrease in the water delivery rate clearly shows that the test cell is functioning properly. Furthermore, even though the water delivery rate was decreased, at no time did the rate of hydrogen generation fall below that required by the fuel cell to power a laptop.

### Example 3

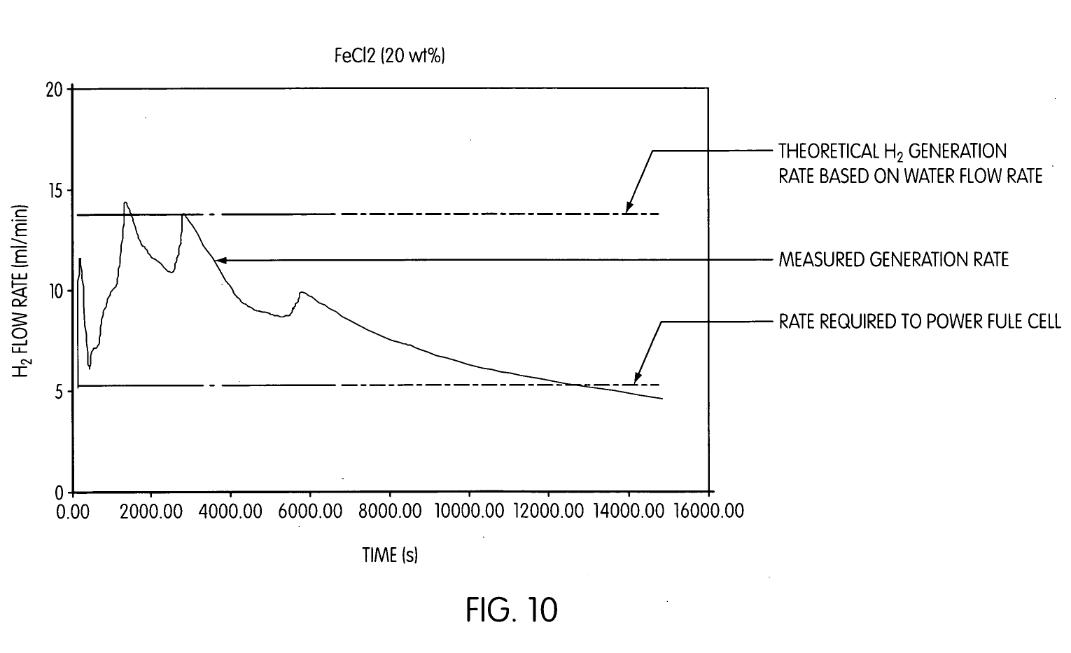

The results of the experiment when the hydrogen-generating solid fuel is sodium borohydride NaBH₄ and the catalyst is 20 wt % FeCl₂ is shown in FIG. 10. The choice of such a catalyst has advantages in that it is relatively inexpensive, and hence such hydrogen-generating solid fuel cartridges containing FeCl₂ may be economically disposable (e.g., a “throwaway” item).

What is claimed is:

1. A hydrogen-generating solid fuel cartridge for reacting a liquid reactant with a solid fuel, the cartridge comprising:
an outer shell of the cartridge;
a mixture of the hydrogen-generating solid fuel and a catalyst contained within the outer shell, the solid fuel/catalyst mixture having a packing fraction greater than about 55 percent;
an entry port in the outer shell for introducing the liquid reactant into the cartridge, the entry port connected to a means for distributing the liquid reactant substantially evenly throughout the solid fuel/catalyst mixture within the cartridge; and
a network of hydrogen-collecting, gas permeable membranes dispersed within the solid fuel/catalyst mixture, the network of membranes communicating to at least one hydrogen exit port in the outer shell for removing the hydrogen product from the cartridge.

2. The hydrogen-generating solid fuel cartridge of claim 1, further including a liquid reactant distribution plate, the distribution plate having distribution channels arranged in a fractal pattern, one end of the fractal pattern connected to the entry port in the outer shell, the other end of the fractal pattern connected to the means for distributing the liquid reactant throughout the solid fuel/catalyst mixture.

3. The hydrogen-generating solid fuel cartridge of claim 1, wherein the solid fuel is selected from the group consisting of sodium borohydride (NaBH₄), lithium borohydride (LiBH₄), magnesium borohydride (Mg(BH₄)₂), calcium borohydride (Ca(BH₄)₂), aluminum borohydride (Al(BH₄)₃), zinc borohydride (Zn(BH₄)₂), potassium borohydride (KBH₄), lithium aluminum hydride (LiAlH₄), and sodium boron trimethoxyhydride (NaBH(OCH₃)₃).

4. The hydrogen-generating solid fuel cartridge of claim 3, wherein the solid fuel further includes a solid material having an acidic hydrogen.

5. The hydrogen-generating solid fuel cartridge of claim 1, wherein the liquid reactant comprises water.

6. The hydrogen-generating solid fuel cartridge of claim 5, wherein the liquid reactant further comprises an alcohol selected from the group consisting of methanol, ethanol, propanol, isopropanol, and a protic sovent.

7. The hydrogen-generating solid fuel cartridge of claim 1, wherein the catalyst of the mixture comprises a nano-particle of a metallic element selected from the group consisting of Ru, Co, Fe, Ni, W, V, Mo, and Cu.

8. The hydrogen-generating solid fuel cartridge of claim 1, wherein the catalyst of the mixture comprises a nano-particle of a metallic compound with the metal selected from the group consisting of Ru, Co, Fe, Ni and Cu, wherein the Ru, Co, Fe, Ni or Cu compound is reduced to metallic Ru, Co, or Fe by reacting with the hydrogen-containing solid fuel.

9. The hydrogen-generating solid fuel cartridge of claim 7, wherein the catalyst is selected from the group consisting of fluorides, chlorides or bromides of Ru, Co, Fe, Ni or Cu.

10. The hydrogen-generating solid fuel cartridge of claim 1, wherein the means for distributing the liquid reactant comprises a network of hollow fibers.

11. The hydrogen-generating solid fuel cartridge of claim 1, wherein the means for distributing the liquid reactant comprises a network of liquid permeable membranes.

12. The hydrogen-generating solid fuel cartridge of claim 10, wherein the means for distributing the liquid reactant comprises a network of fibrous membranes.

13. The hydrogen-generating solid fuel cartridge of claim 12, wherein network fibrous membranes comprise strips of filter paper.

14. The hydrogen-generating solid fuel cartridge of claim 1, wherein the network of hydrogen-collecting, gas permeable membranes is hydrophobic, such that the network does not substantially transport liquid reactant.

15. The hydrogen-generating solid fuel cartridge of claim 1, wherein the gas permeable membranes is an aerogel foam.

16. A portable proton exchange membrane (PEM) fuel cell battery, comprising:
a hydrogen-generating solid fuel cartridge comprising a mixture of the hydrogen-generating solid fuel and a catalyst, the mixture having a packing fraction greater than about 55 percent, the cartridge further including a liquid reactant input and a hydrogen gas output;
a PEM fuel cell connected to the hydrogen output of the solid fuel cartridge; and
a means for recycling water produced by the PEM fuel cell back to the solid fuel cartridge.

17. The PEM fuel cell battery of claim 16, further including a liquid reactant reservoir for supplying additional liquid reactant to the solid fuel cartridge.

18. The PEM fuel cell battery of claim 17, wherein the liquid reactant reservoir is configured to deliver liquid reactant to the solid fuel cartridge to initiate a hydrogen-generating reaction within the cartridge.

19. The PEM fuel cell battery of claim 16, wherein the liquid reactant is water.

20. The PEM fuel cell battery of claim 16, wherein the means for recycling water to the solid fuel cartridge further includes a gas/liquid separator for separating the water product and unreacted oxidant exiting the fuel cell battery.

21. The PEM fuel cell battery of claim 17, further including a valve between the liquid reactant reservoir and the solid fuel cartridge for regulating the flow of liquid reactant from the reservoir to the cartridge.
